(19) United States
(12) Patent Application Publication
(10) Pub. No.: US 2025/0172753 A1
(43) Pub. Date: May 29, 2025

(54) OPTICAL SOLID STATE DEVICE INCLUDING EVANESCENTLY COUPLED OPTICAL WAVEGUIDES IN A STITCHED RETICLE FIELD AND METHODS OF FORMING THE SAME

(71) Applicant: PSIQUANTUM, CORP., Palo Alto, CA (US)

(72) Inventors: Alexey VERT, Clifton Park, NY (US); Vimal KAMINENI, Mechanicville, NY (US); Erik R. HOSLER, Thompsontown, PA (US); Francois X. MUSALEM, Austin, TX (US)

(21) Appl. No.: 18/962,451

(22) Filed: Nov. 27, 2024

Related U.S. Application Data
(60) Provisional application No. 63/603,935, filed on Nov. 29, 2023.

(51) Int. Cl. G02B 6/122; G02B 6/13

(52) U.S. Cl. CPC G02B 6/1228; G02B 6/13

(57) ABSTRACT

A solid state device includes a first optical waveguide located in a first reticle field, a second optical waveguide located in a second reticle field, a stitching field located in an overlap region between the first reticle field and the second reticle field, and a coupler contacting an evanescent optical coupling region located in the stitching field. A portion of the first optical waveguide which extends into the coupler and is evanescently optically coupled to a portion of the second optical waveguide which extends into the coupler.

### FIELD

The present disclosure relates to a solid state devices in general and more particularly to optical solid state devices including evanescently coupled optical waveguides in a stitched reticle field, and methods of forming the same.

### BACKGROUND

Conventional optical chips or die are fabricated as discrete components and then optically integrated by connecting them with an optical fiber during packaging. The optical fiber is attached to both optical chips through optical couplers, and optical signals can be routed between the optical chips after the fiber is attached to the chips at the package level.

However, the optical fiber attachment may require a complex assembly. Furthermore, a large optical loss of the optical signal may be occur at the attachment points of the optical fiber. Finally, very little photolithographic misalignment can be tolerated during the manufacture of the optical chips in order to avoid misalignment between the optical fiber and the optical couplers.

### SUMMARY

According to an aspect of the present disclosure, a solid state device includes a first optical waveguide located in a first reticle field, a second optical waveguide located in a second reticle field, a stitching field located in an overlap region between the first reticle field and the second reticle field, and a coupler contacting an evanescent optical coupling region located in the stitching field. A portion of the first optical waveguide which extends into the coupler and is evanescently optically coupled to a portion of the second optical waveguide which extends into the coupler.

According to another aspect of the present disclosure, a method of forming a solid state device comprises forming a first optical waveguide in a first reticle field over a top surface of a substrate using a first reticle; forming a second optical waveguide in a second reticle field over the top surface of the substrate using a second reticle; and forming a coupler comprising an evanescent optical coupling region located in a stitching field in an overlap region between the first reticle field and the second reticle field, wherein a portion of the first optical waveguide which extends into the coupler is evanescently optically coupled to a portion of the second optical waveguide which extends into the coupler.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the Figures.

FIG. 1 is a plan view (e.g., top view) of a solid state device according to one or more embodiments.

FIG. 2 illustrates a detailed plan view of region of the solid state device in FIG. 1 according to one or more embodiments.

FIG. 3A illustrates a vertical cross-sectional view of the first sidewall of the first die according to one or more embodiments.

FIG. 3B illustrates a vertical cross-sectional view of the second sidewall of the second die according to one or more embodiments.

FIG. 4A illustrates a vertical cross-sectional view along the line A-A′ in FIGS. 2, 4B and 4C of a solid state device having in-plane coupling between waveguides extending perpendicular to edges of reticle fields according to a first embodiment.

FIG. 4B illustrates a plan view the solid state device of FIG. 4A according to the first embodiment.

FIG. 4C illustrates a vertical cross-sectional view of along the line C-C′ of the solid state device in FIGS. 4A and 4B according to the first embodiment.

FIG. 5 illustrates a plan view of a solid state device having in-plane coupling between waveguides extending parallel to edges of reticle fields according to a second embodiment.

FIG. 6A illustrates a vertical cross-sectional view along the line A-A′ in FIGS. 2, 6B and 6C of a solid state device having out-of-plane coupling between waveguides extending perpendicular to edges of reticle fields according to a third embodiment.

FIG. 6B illustrates a plan view the solid state device of FIG. 6A according to the third embodiment.

FIG. 6C illustrates a vertical cross-sectional view of along the line C-C′ of the solid state device in FIGS. 6A and 6B according to the third embodiment.

FIG. 7 illustrates a plan view of a solid state device having out-of-plane coupling between waveguides extending parallel to edges of reticle fields according to a fourth embodiment.

FIG. 8 illustrates a vertical cross-sectional view of a solid state device having both in-plane and out-of-plane coupling between waveguides according to a fifth embodiment.

### DETAILED DESCRIPTION

As discussed above, the embodiments of the present disclosure are directed optical solid state devices including evanescently coupled optical waveguides in a stitched reticle field located between adjacent optical solid state devices, and methods of forming the same, the various aspects of which are discussed herein in detail. The drawings are not necessarily drawn to scale. Multiple instances of an element may be duplicated where a single instance of the element is illustrated, unless absence of duplication of elements is expressly described or clearly indicated otherwise. Ordinals such as “first,” “second,” and “third” are employed merely to identify similar elements, and different ordinals may be employed across the specification and the claims of the instant disclosure. The same reference numerals refer to the same element or similar element. Unless otherwise indicated, elements having the same reference numerals are presumed to have the same composition. As used herein, a first element located “on” a second element can be located on the exterior side of a surface of the second element or on the interior side of the second element. As used herein, a first element is located “directly on” a second element if there exist a physical contact between a surface of the first element and a surface of the second element. As used herein, a “layer” refers to a continuous portion of at least one material including a region having a thickness. A layer may consist of a single material portion having a homogeneous composition, or may include multiple material portions having different compositions.

As used herein, a “conductive material” refers to a material having electrical conductivity greater than 1.0×10⁵ S/cm. As used herein, an “insulator material” or a “dielectric material” refers to a material having electrical conductivity less than 1.0×10⁻⁵ S/cm. As used herein, a “semiconducting material” refers to a material having electrical conductivity in the range from 1.0×10⁻⁵ S/cm to 1.0×10⁵ S/cm. As used herein, a “metallic material” refers to a conductive material including at least one metallic element therein. All measurements for electrical conductivities are made at the standard condition.

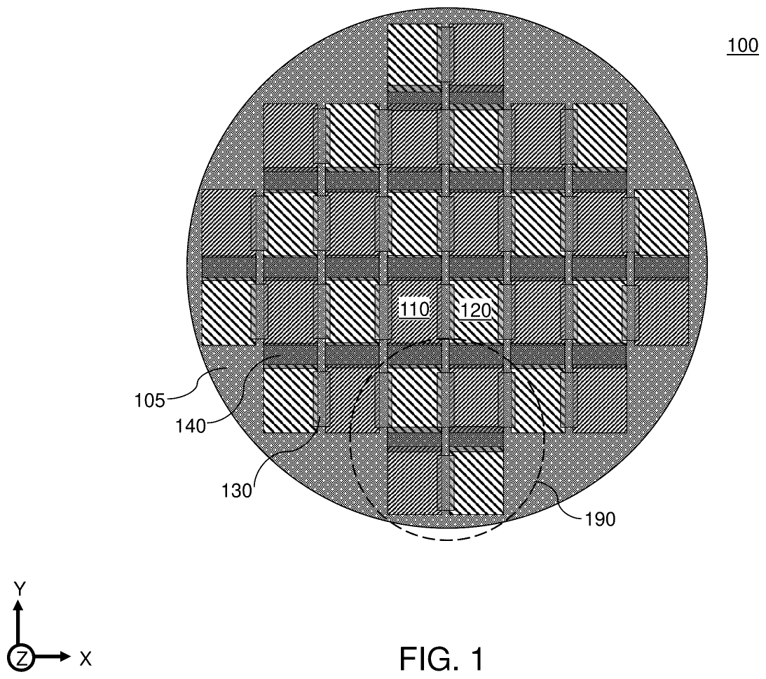

FIG. 1 is a plan view (e.g., top view) of a solid state device 100 according to one or more embodiments. As illustrated in FIG. 1, the solid state device 100 may include a substrate 105. The substrate 105 may include, for example, a semiconductor wafer (e.g., silicon wafer). The solid state device 100 may also include one or more first dies 110 (e.g., first primary dies 110) and one or more second dies 120 (e.g., second primary dies 120). The first dies 110 and the second dies 120 may be formed (e.g., grown layer by layer and patterned by a suitable patterning method, etc.) on the substrate 105.

The first dies 110 may have a first die type. The second dies 120 may have a second die type that is different than the first die type. Each of the first dies 110 and the second dies 120 may include, for example, a photonic IC die, an electronic IC die, a hybrid IC die (e.g., a die including both photonic and electronic elements), or another type of IC die.

The first dies 110 and second dies 120 may be organized on the substrate 105 into a regular array. In at least one embodiment, about half of the total dies (e.g., the total number of first dies 110 and second dies 120) in the solid state device 100 may include the first dies 110 and the other half may include the second dies 120. In at least one embodiment, the first dies 110 and the second dies 120 may be alternatingly formed in the x-direction and alternatingly formed in the y-direction. The solid state device 100 may include one or more first stitching fields (i.e., stitching regions) 130 between a first die 110 and a second die 120 and extending longitudinally in the y-direction. The solid state device 100 may include one or more second stitching fields 140 between a first die 110 and a second die 120 and extending longitudinally in the x-direction.

It should be noted that less that all of the first dies 110 and second dies 120 may be stitched together. For example, the solid state device 100 may include only first stitching fields 130 or only second stitching fields 140, or only some of the first and/or second stitching fields.

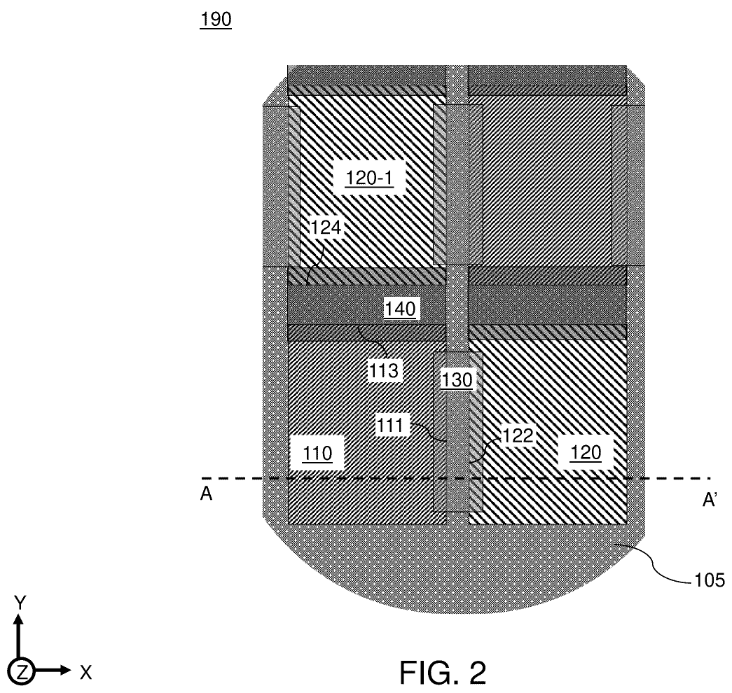

FIG. 2 illustrates a detailed plan view of region 190 of the solid state device 100 in FIG. 1 according to one or more embodiments. As illustrated in FIG. 2, the first die 110 may include a first sidewall 111 and one the second dies 120 may include a second sidewall 122. The first sidewall 111 of the first die 110 may face the second sidewall 122 of the second die 120. A first stitching field 130 (e.g., horizontal stitching region) may be located between the first sidewall 111 of the first die 110 and the second sidewall 122 of the second die 120. In addition, the first die 110 may include a third sidewall 113 and the another one of the second dies 120 (e.g., die 120-1) may include a fourth sidewall 124. The third sidewall 113 of the first die 110 may face the fourth sidewall 124 of the second die 120-1. A second stitching field 140 (e.g., vertical stitching region) may be located between the third sidewall 113 of the first die 110 and the fourth sidewall 124 of the second die 120-1.

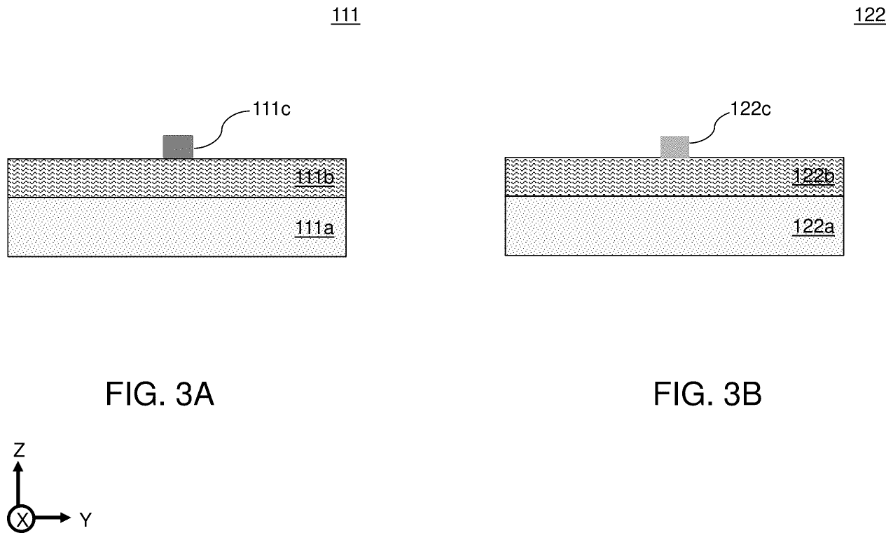

FIG. 3A illustrates a vertical cross-sectional view of the first sidewall 111 of the first die 110 according to one or more embodiments. As illustrated in FIG. 3A, at the first sidewall 111, the first die 110 may include a substrate layer 111a (e.g., silicon layer). An oxide layer 111b (e.g., buried oxide layer (BOX)) may be located on the substrate layer 111a. The oxide layer 111b may include, for example, silicon dioxide and may serve as a bottom cladding layer. One or more optical waveguides 111c (e.g., channel waveguide) may be located on the oxide layer 111b. The optical waveguides 111c may include, for example, a semiconductor material (e.g., silicon, germanium, etc.). Alternatively, the optical waveguides 111c may include an insulating material, such as silicon nitride instead of or in addition to the semiconductor material. An optional blocking layer (not shown) may be located on the optical waveguides 111c. The blocking layer may include, for example, a silicide layer, such as nickel silicide.

FIG. 3B illustrates a vertical cross-sectional view of the second sidewall 122 of the second die 120 according to one or more embodiments. At the second sidewall 122, the second die 120 may have a configuration that is the same or different than the configuration of the first sidewall 111. As illustrated in FIG. 3B, at the second sidewall 122, the second die 120 may include a substrate layer 122a (e.g., silicon layer). An oxide layer 122b (e.g., buried oxide layer (BOX)) may be located on the substrate layer 122a. The oxide layer 122b may include, for example, silicon dioxide and may serve as a bottom cladding layer. One or more optical waveguides 122c (e.g., channel waveguide) may be located on the oxide layer 122b. The optical waveguides 122c may include, for example, a semiconductor material (e.g., silicon, germanium, etc.). Alternatively, the optical waveguides 122c may include an insulating material, such as silicon nitride instead of or in addition to the semiconductor material. An optional blocking layer (not shown) may be located on the optical waveguides 122c. The blocking layer may include, for example, a silicide layer, such as nickel silicide.

The first sidewall 111 in FIG. 3A and second sidewall 122 in FIG. 3B may include additional elements (e.g., cladding layer, dielectric layers, back end of line (BEOL) interconnects, etc.) on the oxide layers and the optical waveguides. These additional elements are not shown in FIGS. 3A and 3B for ease of understanding. Further, while the first optical waveguide 111c in FIG. 3A and the second optical waveguide 122c in FIG. 3B are illustrated as being in a center (in the y-direction) of the first sidewall 111 and the second sidewall 122, respectively, the first optical waveguide 111c and second optical waveguide 122c may alternatively be offset from the center. In at least one embodiment, the first optical waveguide 111c and second optical waveguide 122c may be offset from the center in opposite directions in the y-direction.

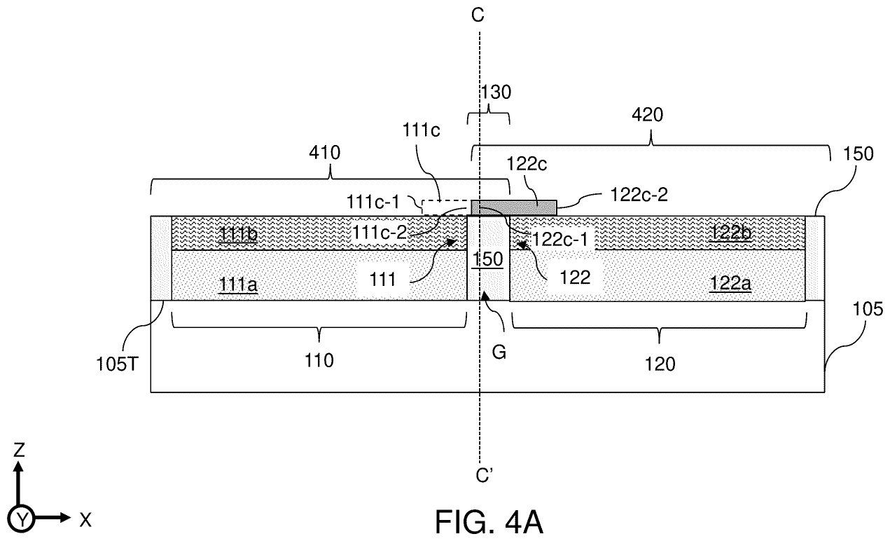

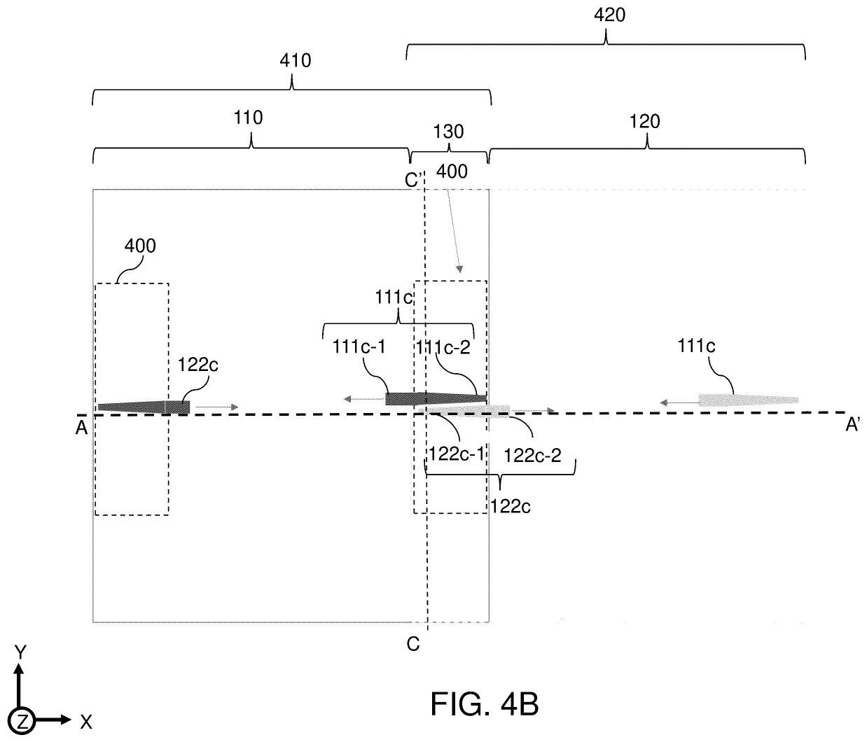

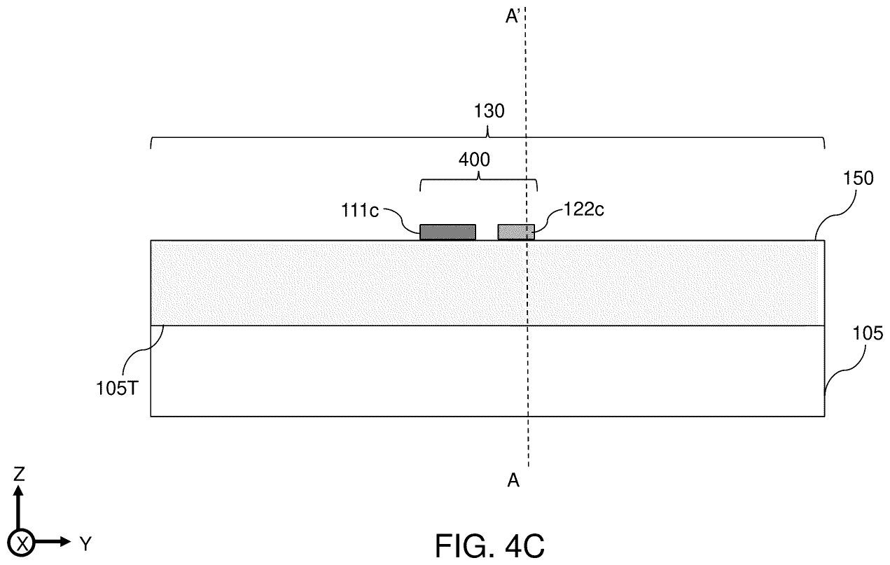

FIGS. 4A-4C illustrate an optical solid state device having in-plane evanescent coupling between waveguides extending perpendicular to edges of the stitching field of first and second reticle fields used to fabricate the respective first die 110 and second die 120 according to the first embodiment. In particular, FIG. 4A illustrates a vertical cross-sectional view along the line A-A′ in FIG. 2. As illustrated in FIG. 4A, the second die 120 may be located adjacent to the first die 110 over the top surface 105T of the same substrate 105 as the first die 110. In particular, the first sidewall 111 of the first die 110 may face the second sidewall 122 of the second die 120, with an optional gap G formed between the first sidewall 111 and the second sidewall 122. A dielectric encapsulation layer 150 (e.g., silicon dioxide) may be formed on the first die 110 and second die 120 and in the gap G.

The first optical waveguide 111c of the first die 110 may include a first optical waveguide end 111c-1 that may be coupled to an optical circuit (not shown) in the first die 110. The second optical waveguide 122c of the second die 120 may include a second optical waveguide end 122c-2 that may be coupled to an optical circuit (not shown) in the second die 120. The optical circuits in the first and second dies may include any suitable devices, such as optical switches, optical detectors, optical couplers, additional waveguides, etc.

The first die 110 may be formed by photolithography and etching of various optical device layers using a first reticle in a first reticle field 410 to expose at least one photoresist layer during the photolithography step. The second die 120 may be formed by photolithography and etching of various optical device layers using a second reticle in a second reticle field 420 to expose at least one photoresist layer during the photolithography step. The first stitching field 130 is located in the overlap region between the first reticle field 410 and the second reticle field 420, and may be exposed through both the first and the second reticles. It should be noted that the first and the second reticles may comprise separate reticles or the same reticle which is laterally stepped in the x-direction during sequential exposures of the photoresist layer located in the overlapping first and second reticle fields. The first stitching field 130 may be referred to as a “frame drop-in region”. The first stitching field 130 may, therefore, include the first sidewall 111 of the first die 110, the gap G, and the second sidewall 122 of the second die 120.

The first stitching field 130 may further include an evanescent optical coupling region (referred to as a “coupler” for brevity herein) 400 which includes portions of the first and second optical waveguides 111c, 122c. The first waveguide 111c includes a second end 111c-2 which extends into the coupler 400. The second waveguide 122c includes a first end 122c-1 which extends into the coupler 400.

The coupler 400 may be located over the dielectric encapsulation layer 150 and may extend across the gap G in the x-direction. The coupler 400 may evanescently couple the first optical waveguide 111c (e.g., the second end 111c-2 of waveguide 111c) to the second optical waveguide 122c (e.g., to the first end 122c-1 of waveguide 122c) in the stitched reticle field 130 between the first reticle field 410 and the second reticle field 420. Evanescent optical coupling between two adjacent optical waveguides 111c, 122c occurs where the cores of the respective waveguides are located sufficiently close to each other without touching each other, so that an evanescent optical field generated by one or more photons in one core excites an optical wave in the other core. As illustrated in FIG. 4A, the first optical waveguide 111c and the second optical waveguide 122c are located in the same horizontal plane in the vertical z-direction. Thus, the evanescent coupling includes side-by-side in-plane evanescent coupling. Thus, the second end 111c-2 of the first optical waveguide 111c is evanescently optically coupled to the first end 122c-1 of the second optical waveguide 122c in the coupler 400.

The first optical waveguide 111c may extend in the coupler 400 perpendicular to an edge of the first reticle field 410 (e.g., perpendicular to the first sidewall 111) and to a y-direction edge of the stitching field 130. The second optical waveguide 122c may extend in the coupler 400 perpendicular to a y-direction edge of the second reticle field 420 (e.g., perpendicular to the second sidewall 122) and to an edge of the stitching field 130.

In the first embodiment illustrated in FIGS. 4B and 4C, the first optical waveguide 111c may be offset in the y-direction from the second waveguide 122c in the coupler 400. Optionally, the second end 111c-2 of the first optical waveguide 111c may be tapered and have a width in the y-direction that gradually decreases in the x-direction direction toward the second die 120. Optionally, the first end 122c-1 of the second optical waveguide 122c may be tapered and have a width in the y-direction that gradually decreases in the direction opposite to the x-direction direction toward the first die 110.

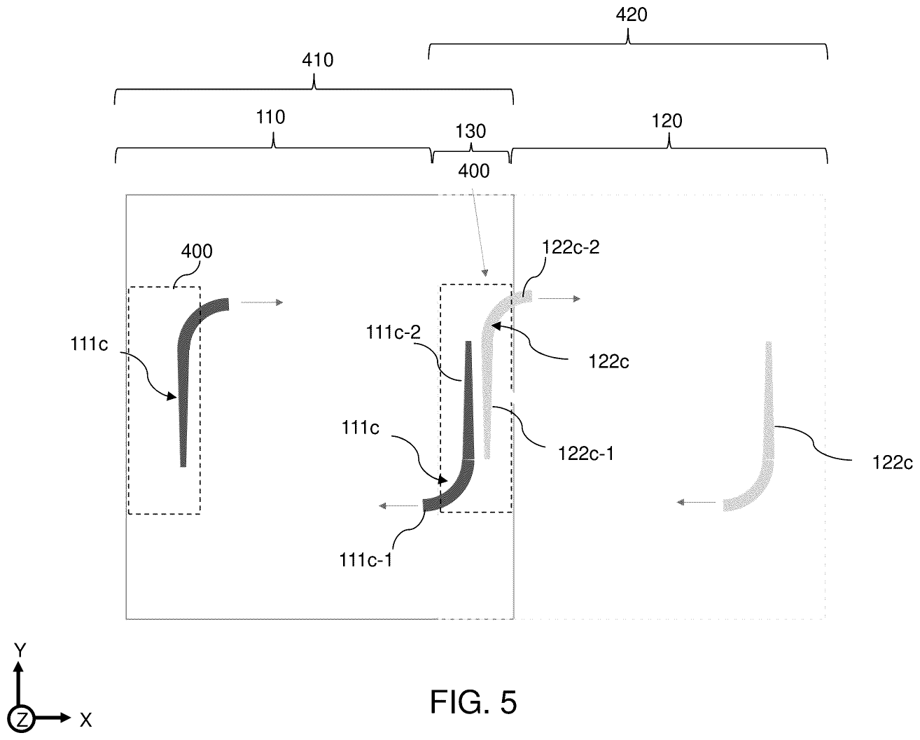

FIG. 5 illustrates a plan view of a solid state device having in-plane coupling between waveguides extending parallel to edges of reticle fields according to the second embodiment. In contrast to the first embodiment, in second embodiment illustrated in FIG. 5, the first optical waveguide 111c may be offset in the x-direction from the second waveguide 122c in the coupler 400. The x-direction is the lateral separation direction between the first die 110 and the second die 120.

Optionally, the second end 111c-2 of the first optical waveguide 111c may be tapered and have a width in the x-direction that gradually decreases in the y-direction direction. Optionally, the first end 122c-1 of the second optical waveguide 122c may be tapered and have a width in the x-direction that gradually decreases in the direction opposite to the y-direction.

In the second embodiment, the second end 111c-2 of the first optical waveguide 111c may extend in the coupler 400 parallel to an edge of the first reticle field 410 (e.g., parallel to the first sidewall 111) and a y-direction edge of stitching field 130. The first end 122-c1 of the second optical waveguide 122c may extend in the coupler 400 parallel to an edge of the second reticle field 420 (e.g., parallel to the second sidewall 122) and a y-direction edge of the stitching field 130.

Since the first optical waveguide 111c is located in the same horizontal plane as the second optical waveguide 122c in the first and second embodiments, the waveguides preferably comprise the same material (e.g., silicon) for ease of fabrication. The waveguides may be fabricated by forming a waveguide core layer (e.g., a silicon layer) over the dielectric encapsulation layer 150, which may function as the bottom cladding for the waveguide cores. The waveguide core layer is then patterned by photolithography and etching into the cores of the first optical waveguide 111c and the second optical waveguide 122c. A second cladding layer (e.g. silicon oxide) is then formed over the cores. The photoresist layer used during the photolithography may be exposed twice in the stitching field 130 through the first and the second reticles.

Thus, in the first and second embodiments, the second end 111c-2 of the first optical waveguide 111c is laterally offset from the first end 122c-1 of the second optical waveguide 122c in the coupler 400 in the horizontal direction (e.g., in the y-direction, in the x-direction, in both the x and y-directions and/or in a direction between the x and y-directions). However, the second end 111c-2 of the first optical waveguide 111c is located in the same horizontal plane as the first end 122c-1 of the second optical waveguide 122c in the coupler 400.

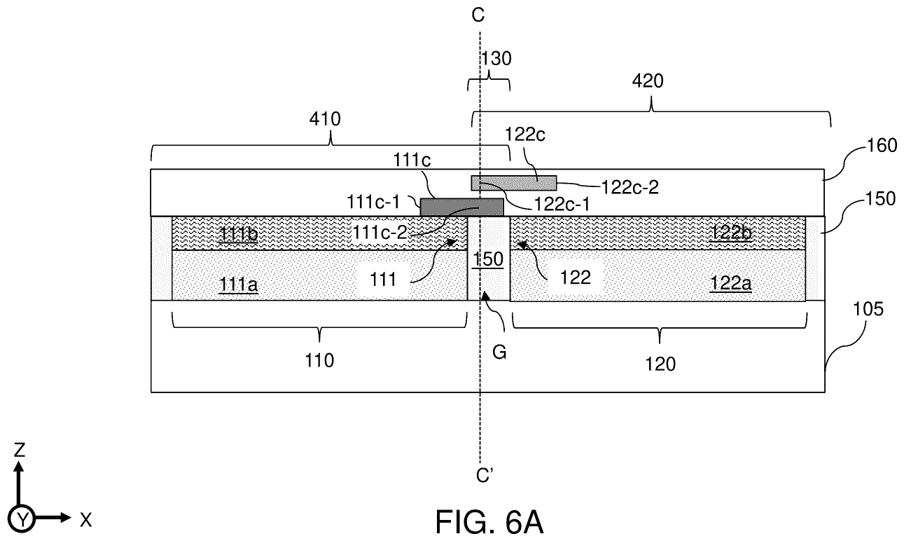

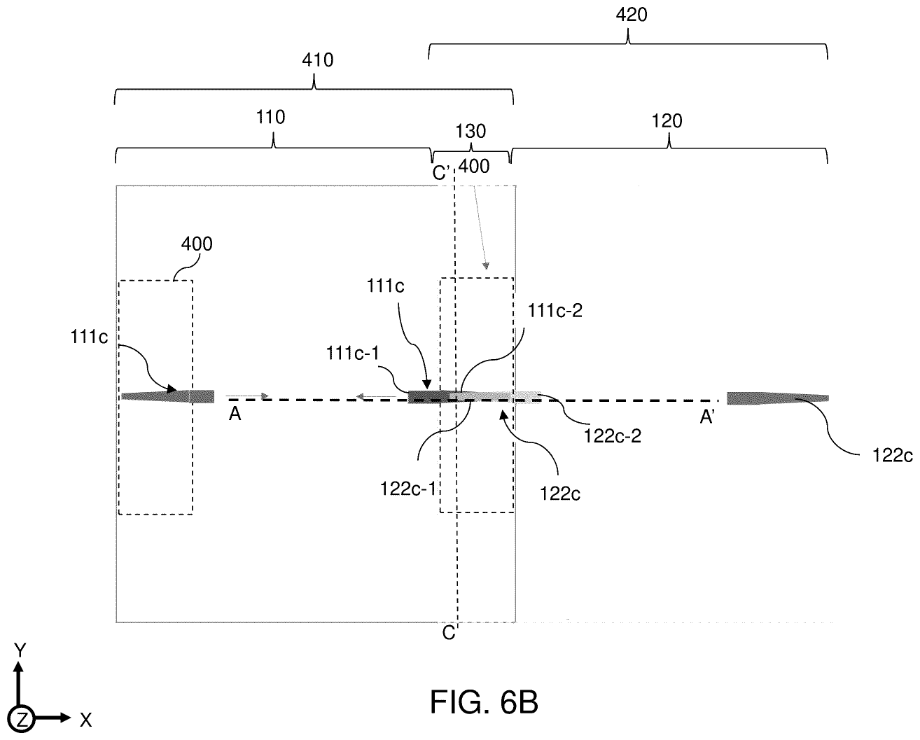

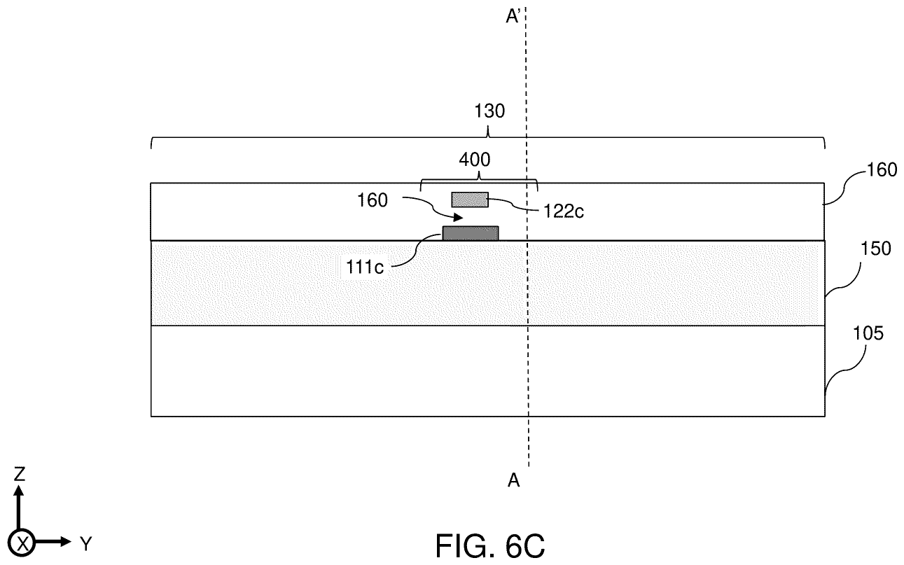

FIGS. 6A-6C illustrate an optical solid state device having out-of-plane evanescent coupling between waveguides extending perpendicular to edges of the stitching field of first and second reticle fields used to fabricate the respective first die 110 and second die 120 according to the third embodiment. The third embodiment differs from the first embodiment in that the second end 111c-2 of the first optical waveguide 111c is offset from the first end 122c-1 of the second optical waveguide 122c in the vertical direction (i.e., in the z-direction which extends normal to the top surface 105T of the substrate 105) in the coupler 400. In FIGS. 6A-6C, the second end 111c-2 of the first optical waveguide 111c is located below the first end 122c-1 of the second optical waveguide 122c in the coupler 400. However, in an alternative embodiment, the second end 111c-2 of the first optical waveguide 111c may be located above the first end 122c-1 of the second optical waveguide 122c in the coupler 400.

A separation layer 160 is located at least between the second end 111c-2 of the first optical waveguide 111c and the first end 122c-1 of the second optical waveguide 122c in the vertical direction. The separation layer 160 may comprise a waveguide cladding material layer, such as silicon oxide. The separation layer 160 is located in the coupler 400 between the first die 110 and the second die 120. Optionally, the separation layer 160 may extend into the first die 110 and/or into the second die 120, and/or may also overlie the upper optical waveguide (e.g., the second optical waveguide 122c in FIGS. 6A-6C). The portion of the separation layer 160 located between the first optical waveguide 111c and over the second optical waveguide 122c in the coupler 400 may have a thickness in range of greater than 0 Å and equal or less than 10,000 Å, such as 10 Å to 10,000 Å, for example 20 Å to 1,000 Å

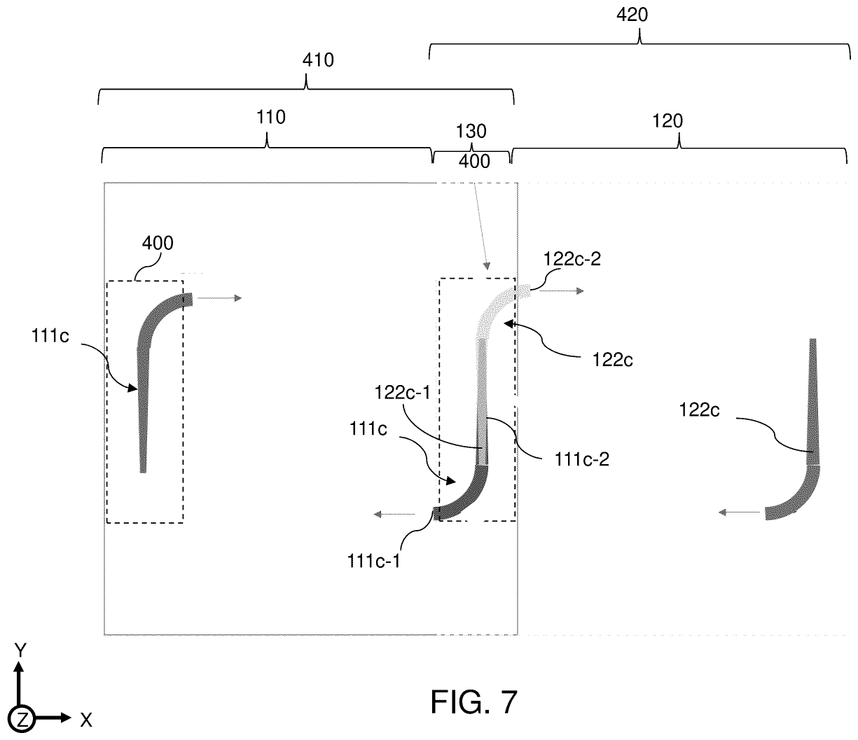

FIG. 7 illustrates a plan view of a solid state device having out-of-plane coupling between waveguides extending parallel to edges of reticle fields according to the fourth embodiment. The fourth embodiment differs from the second embodiment in that the second end 111c-2 of the first optical waveguide 111c is offset from the first end 122c-1 of the second optical waveguide 122c in the vertical direction (i.e., in the z-direction which extends normal to the top surface of the substrate 105) in the coupler 400.

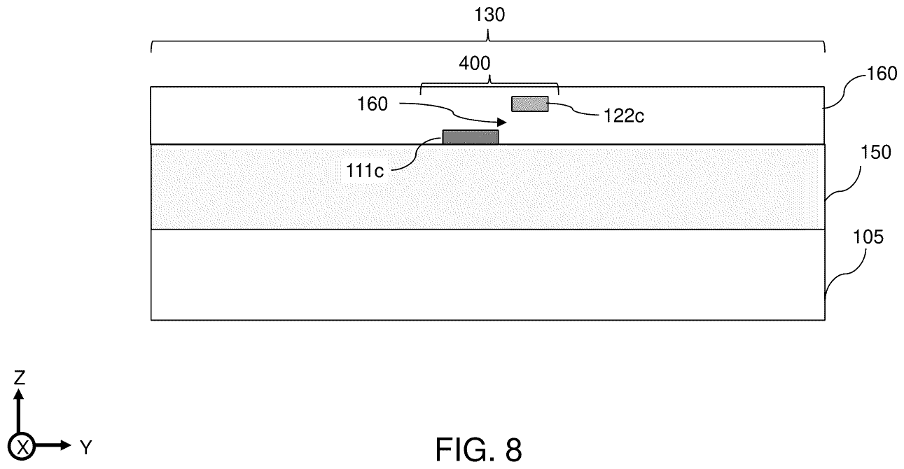

FIG. 8 illustrates a vertical cross-sectional view of a solid state device having both in-plane and out-of-plane coupling between waveguides according to the fifth embodiment. The fifth embodiment differs from the third and fourth embodiments in that that the second end 111c-2 of the first optical waveguide 111c is offset from the first end 122c-1 of the second optical waveguide 122c in both the horizontal direction and in the vertical direction in the coupler 400. The horizontal direction may comprise the y-direction as shown in FIG. 8, the x-direction, both the x and the y-directions, and/or a direction between the x and the y-directions. Thus, the second end 111c-2 of the first optical waveguide 111c is both laterally and vertically separated from the first end 122c-1 of the second optical waveguide 122c in the coupler 400.

In the third, fourth and fifth embodiments, the first and second waveguides 111c, 122c may comprise the same material or different materials from each other. For example, one of the waveguides may comprise silicon and the other waveguide may comprise silicon nitride. Since the waveguides are located in different vertical planes, they are preferably manufactured by sequentially depositing and photolithographically patterning different layers in different vertical planes over the substrate.

In summary, in the first and second embodiments, evanescent coupling may be achieved through the side-by-side, in-plane coupling. In the first embodiment, the waveguides are aligned in the direction perpendicular to the reticle edge in the coupler. In the second embodiment, the waveguides are aligned in the direction parallel to the reticle edge in the coupler. In the third and fourth embodiments, evanescent coupling may be achieved through the vertical, out-of-plane coupling. In the third embodiment, the waveguides are aligned in the direction perpendicular to the reticle edge in the coupler. In the fourth embodiment, the waveguides are aligned in the direction parallel to the reticle edge in the coupler. In the fifth embodiment, evanescent coupling may be achieved through both the in-plane and the out-of-plane coupling. The waveguides may be aligned at any angle relative to the reticle edge, as long as it fits inside the frame region of the reticle.

Evanescent optical coupling between two optical waveguides in the coupler located in the stitching field between adjacent reticle fields provides optical signal routing with low optical loss and without requiring attaching an optical fiber between optical dies during the die packaging, which simplifies manufacturing. The optical low loss transition between adjacent reticle fields on the same substrate permits fabrication of an integrated optical device (e.g., multi-die optical device on the same substrate) whose size exceeds maximum size allowed by the reticle. Potential misalignment caused by reticle stitching of two adjacent fields does not significantly increase the optical loss due to the use of evanescent coupling between the adjacent waveguides which does not require physical contact between the waveguides. Thus, even if the waveguides are misaligned relative to each other in the coupler, the evanescent coupling between the waveguides still occurs.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1. A solid state device, comprising:
a first optical waveguide located in a first reticle field;
a second optical waveguide located in a second reticle field;
a stitching field located in an overlap region between the first reticle field and the second reticle field; and
a coupler comprising an evanescent optical coupling region located in the stitching field, wherein a portion of the first optical waveguide which extends into the coupler and is evanescently optically coupled to a portion of the second optical waveguide which extends into the coupler.

2. The solid state device of claim 1, wherein:
the portion of the first optical waveguide which extends into the coupler comprises a second end of the first optical waveguide; and
the portion of the second optical waveguide which extends into the coupler comprises a first end of the second optical waveguide.

3. The solid state device of claim 2, further comprising:
a substrate having a top surface;
a first die located over the top surface of the substrate in the first reticle field; and
a second die located over the top surface of the substrate in the second reticle field.

4. The solid state device of claim 3, wherein:
the first optical waveguide further comprises a first end that is coupled to a first optical circuit located in the first die; and
the second optical waveguide further comprises a second end that is coupled to a second optical circuit located in the second die.

5. The solid state device of claim 3, wherein:
the second end of the first optical waveguide is tapered; and
the first end of the second optical waveguide is tapered.

6. The solid state device of claim 3, wherein:
the second end of the first optical waveguide and the first end of the second optical waveguide are located in a same vertical plane relative to the top surface of the substrate; and
the second end of the first optical waveguide and the first end of the second optical waveguide are evanescently optically coupled in-plane and laterally separated from each other in the coupler.

7. The solid state device of claim 6, wherein:
the second end of the first optical waveguide extends perpendicular to an edge of the first reticle field in the coupler; and
the first end of the second optical waveguide extends perpendicular to an edge of the second reticle field in the coupler.

8. The solid state device of claim 6, wherein:
the second end of the first optical waveguide extends parallel to an edge of the first reticle field in the coupler; and
the first end of the second optical waveguide extends parallel to an edge of the second reticle field in the coupler.

9. The solid state device of claim 3, wherein:
the second end of the first optical waveguide and the first end of the second optical waveguide are located in different vertical planes relative to the top surface of the substrate; and
the second end of the first optical waveguide and the first end of the second optical waveguide are evanescently optically coupled out-of-plane and vertically separated from each other in the coupler.

10. The solid state device of claim 9, wherein the second end of the first optical waveguide and the first end of the second optical waveguide both laterally and vertically separated from each other in the coupler.

11. A method of forming a solid state device, comprising:
forming a first optical waveguide in a first reticle field over a top surface of a substrate using a first reticle;
forming a second optical waveguide in a second reticle field over the top surface of the substrate using a second reticle; and
forming a coupler comprising an evanescent optical coupling region located in a stitching field in an overlap region between the first reticle field and the second reticle field, wherein a portion of the first optical waveguide which extends into the coupler is evanescently optically coupled to a portion of the second optical waveguide which extends into the coupler.

12. The method of claim 11, wherein:
the portion of the first optical waveguide which extends into the coupler comprises a second end of the first optical waveguide; and
the portion of the second optical waveguide which extends into the coupler comprises a first end of the second optical waveguide.

13. The method of claim 12, further comprising:
forming a first die located over the top surface of the substrate in the first reticle field using a first reticle; and
forming a second die located over the top surface of the substrate in the second reticle field using a second reticle,
wherein:
the first optical waveguide further comprises a first end that is coupled to a first optical circuit located in the first die; and
the second optical waveguide further comprises a second end that is coupled to a second optical circuit located in the second die.

14. The method of claim 13, wherein the second reticle either comprises a different reticle from the first reticle or comprises the same reticle as the first reticle which is laterally translated over the top surface to the second reticle field.

15. The method of claim 13, wherein a photoresist layer in the first reticle field is exposed through the first reticle and a same or different photoresist layer is exposed through the second reticle.

16. The method of claim 13, wherein:
the second end of the first optical waveguide and the first end of the second optical waveguide are located in a same vertical plane relative to the top surface of the substrate; and
the second end of the first optical waveguide and the first end of the second optical waveguide are evanescently optically coupled in-plane and are laterally separated from each other in the coupler.

17. The method of claim 16, wherein:
the second end of the first optical waveguide extends perpendicular to an edge of the first reticle field in the coupler; and
the first end of the second optical waveguide extends perpendicular to an edge of the second reticle field in the coupler.

18. The method of claim 16, wherein:
the second end of the first optical waveguide extends parallel to an edge of the first reticle field in the coupler; and
the first end of the second optical waveguide extends parallel to an edge of the second reticle field in the coupler.

19. The method of claim 13, wherein:
the second end of the first optical waveguide and the first end of the second optical waveguide are located in different vertical planes relative to the top surface of the substrate; and
the second end of the first optical waveguide and the first end of the second optical waveguide are evanescently optically coupled out-of-plane and are vertically separated from each other in the coupler by a separation layer.

20. The method of claim 19, wherein the second end of the first optical waveguide and the first end of the second optical waveguide both laterally and vertically separated from each other in the coupler.
